(19) United States
(12) Patent Application Publication
(10) Pub. No.: US 2006/0018215 A1
(43) Pub. Date: Jan. 26, 2006

(54) Optical pickup device

(75) Inventors: Takahiro Miyake, Kyoto (JP); Kentaro Terashima, Nara (JP)

Correspondence Address: EDWARDS & ANGELL, LLP, P.O. BOX 55874, BOSTON, MA, 02205, US

(73) Assignee: Sharp Kabushiki Kaisha, Osaka (JP)

(21) Appl. No.: 11/187,360

(22) Filed: Jul. 21, 2005

(30) Foreign Application Priority Data
Jul. 23, 2004 (JP) 216474/2004

(51) Int. Cl. G11B 7/00

(52) U.S. Cl. 369/44.37; 369/44.41; 369/112.01

(57) ABSTRACT

An object of the present invention is to provide an optical pickup device which improves resolution of reproduced signals without increasing the number of components, and does not require positional adjustment of a grating during assembly of the optical pickup device. For this purpose, the optical pickup device of the present invention includes a semiconductor laser 1, a grating 3, an objective lens 5, and a push-pull signal detecting section 10. The grating 3 divides a light beam emitted from the semiconductor laser 1 into a 0-order diffracted beam, and a pair of ±1st-order diffracted beams. The grating 3 is set so that a reduction rate of light intensity for the 0-order diffracted beam is decreased and intensities of the pair of ±1st-order diffracted beams are decreased from a vicinity of an optical axis toward periphery parts. Accordingly, the 0-order diffracted beam has a flat intensity distribution, and the intensities of the pair of ±1st-order diffracted beams are higher in the vicinity of the optical axis than in the periphery part. Thus, the resolution of reproduced signals can be improved, and the positional adjustment of the grating can be omitted.

This Nonprovisional application claims priority under 35 U.S.C. § 119(a) on Patent Application No. 2004/216474 filed in Japan on Jul. 23, 2004, the entire contents of which are hereby incorporated by reference.

### FIELD OF THE INVENTION

The present invention relates to an optical pickup device. The invention particularly relates to an optical pickup device used in an optical recording and reproducing apparatus which reproduces information from a read-only optical disk, or an optical recording and reproducing apparatus which records and reproduces information in and from a rewritable optical disk.

### BACKGROUND OF THE INVENTION

In an optical pickup device, light emitted from a semiconductor laser beam source generally forms a gaussian distribution. Consequently, a luminous flux incident on an objective lens also forms a gaussian distribution in an optical pickup device, so that its intensity lowers toward the periphery of the objective lens from the center. This reduces the resolution of reproduced signals on a time-axis, because a micro spot cannot be focused on an optical disk. Further, the S/N ratio of the reproduced signals is also reduced because signals recorded in adjacent tracks are included as a crosstalk component in the reproduced signals.

Such problems are overcome in an optical pickup device disclosed in Japanese Laid-Open Patent Publication No. 134972/2001 (Tokukai 2001-134972, publication date: May 18, 2001), for example. In the optical pickup device disclosed in this publication, a grating having land portions and groove portions is provided in a window part of a semiconductor laser module. The grating divides incident light into three beams: a 0-order diffracted beam; a ±1st-order diffracted beam; and a −1st-order diffracted beam. Among these, the 0-order diffracted beam constitutes a luminous flux (recording and reproducing beam) incident on the objective lens and forming a light spot on an optical disk in the optical pickup device. Further, the width and depth of the grating groove, and the grating cycle are set so that the intensity of the 0-order diffracted beam is weak in the center part and strong in the periphery parts of the grating. In such a manner, by flattening the intensity distribution of the 0-order diffracted beam incident on the objective lens, the diameter of the light spot on the optical disk can be reduced. This improves resolution of reproduced signals and significantly reduces crosstalk.

In the optical pickup device disclosed in this publication, the grating only serves to guide the reflected laser beam from an optical disk into multi-part photodetectors and compensate the intensity distribution of the 0-order diffracted beam.

In addition, during assembly of the optical pickup device, the grating position has to be aligned precisely so that diffraction rays other than the recording and reproducing beam, i.e., ±1st-order diffracted beams, irradiate predetermined tracks on the optical disk. Thus, long hours have been required for assembly of the conventional optical pickup device.

### SUMMARY OF THE INVENTION

The present invention was made in view of the above conventional problems, and an object of the present invention is to provide an optical pickup device which can improve resolution of reproduced signals without increasing the number of components constituting an optical system, and which does not require position alignment of a grating during assembly of the optical pickup device.

To attain the foregoing problems, an optical pickup device of the present invention includes a light source; a diffractive optical element for dividing light emitted from the light source into a 0-order diffracted beam and a pair of ±1st-order diffracted beams; converging means for converging the 0-order diffracted beam and the pair of ±1st-order diffracted beams on an optical disk; and push-pull signal detecting means for detecting a push-pull signal from respective spots of the 0-order diffracted beam and the pair of ±1st-order diffracted beams, the diffractive optical element being set so that a reduction rate of light intensity for the 0-order diffracted beam is decreased and respective intensities of the pair of ±1st-order diffracted beams are decreased in a direction from a vicinity of an optical axis toward periphery parts.

According to the arrangement, the light emitted from the light source is divided into the 0-order diffracted beam and the pair of the ±1st-order diffracted beams (herein after referred as ±1st-order diffracted beams) by the diffractive optical element. Then, the 0-order diffracted beam and the ±1st-order diffracted beams are individually converged on the optical disk by the converging means.

The diffractive optical element is set so that the reduction rate of light intensity for the 0-order diffracted beam is decreased from the vicinity of the optical axis toward the periphery parts. Thus, the 0-order diffracted beam incident on the converging means has a uniform and more flat intensity distribution. As a result, the size of its spot formed on the optical disk is reduced. This realizes an optical pickup device in which crosstalk between the tracks on the optical disk is reduced, and high-density data is recorded and reproduced without reducing efficiency of using light.

Further, the diffractive optical element is set so that the respective intensities of the ±1st-order diffracted beams are decreased from in a direction from the vicinity of the optical axis of the respective beams toward the periphery parts. The ±1st-order diffracted beams are incident on the converging means with their light intensities higher in the vicinity of the respective optical axes than in the periphery parts. Thus, the ±1st-order diffracted beams have no incident light in the vicinity of the converging means. Therefore, actual numerical aperture (NA) of the converging means are reduced for the ±1st-order diffracted beams, with the result that the respective spot sizes of spots of the ±1st-order diffracted beams on the optical disk are increased. As a result, amplitudes of signals of the ±1st-order diffracted beams are significantly reduced. Therefore, in the optical pickup device of the present invention, the push-pull signal detecting means detects push-pull signals produced from the respective spots of the ±1st-order diffracted beams, as well as from the spot of the 0-order diffracted beam. Thus, an optical pickup device is realized that causes no offset in a tracking error signal due to shifting of the converging means. In addition, assembly and adjustment of the optical pickup device can be significantly simplified because alignment of the diffractive optical element is not required.

According to the arrangement, an optical pickup device is realized which improves resolution of reproduced signals without increasing the number of components constituting the optical system, and which does not require position alignment of the grating during assembly.

For a fuller understanding of the nature and advantages of the invention, reference should be made to the ensuing detailed description taken in conjunction with the accompanying drawings.

### BRIEF DESCRIPTION OF THE DRAWINGS

FIG. 1 is a cross-sectional view illustrating a schematic structure of an optical pickup device according to one embodiment of the present invention.

FIG. 2 is an explanatory view representing a diffracted a state of light beam passing through a grating of the optical pickup device.

FIG. 3 is a cross-sectional view illustrating a structure of the grating of the optical pickup device.

FIG. 4 is a plan view illustrating a specific structure of a grating of the optical pickup device, in which FIG. 4(a) shows a structure of a grating surface of the grating, FIG. 4(b) shows another structure of a grating surface of the grating, and FIG. 4(c) shows still another structure of a grating surface of the grating.

FIG. 5 is a circuit diagram illustrating a circuit for detecting a tracking error signal TES in the optical pickup device.

FIG. 6 is a schematic view illustrating diffraction patterns of diffracted light beams on an optical disk when a light beam irradiates on the optical disk.

FIG. 7 is a plan view illustrating spots of reflected beams received by light receiving sections of a reflected light receiver in the optical pickup device.

FIG. 8 is a graph representing changes in amplitudes of push-pull signals caused by shifting of an objective lens in the optical pickup device.

FIG. 9 is a cross-sectional view illustrating a schematic structure of an optical pickup device according to another embodiment of the present invention.

### DESCRIPTION OF THE EMBODIMENTS

### First Embodiment

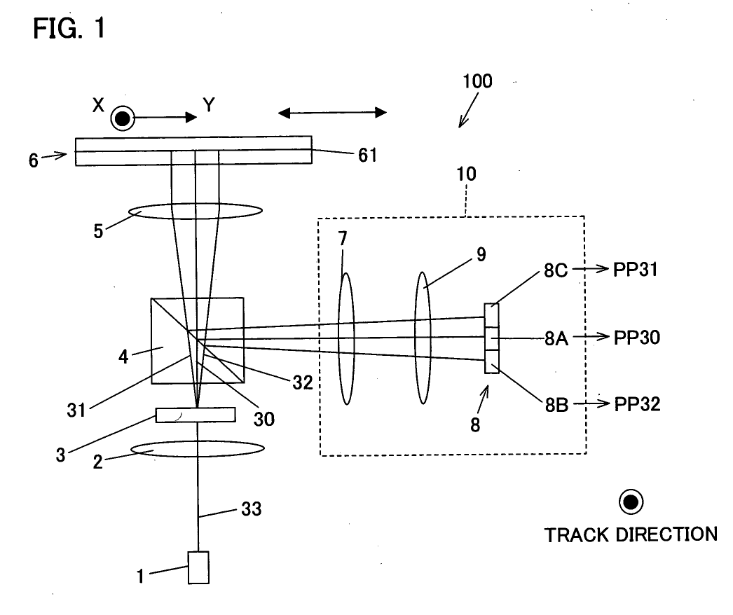

With reference to FIGS. 1 through 5, one embodiment of the present invention is described below.

FIG. 1 is a cross-sectional view illustrating a schematic structure of an optical pickup device 100 of the present invention. As shown in FIG. 1, the optical pickup device 100 includes a semiconductor laser (light source) 1, a collimator lens 2, a grating (diffractive optical element) 3, a beam splitter 4, an objective lens (converging means) 5, and a push-pull signal detecting section (push-pull signal detecting means) 10.

The collimator lens 2 converts a light beam 33 emitted from the semiconductor laser 1 into parallel light. The grating 3 divides the incident light beam into three diffracted beams: a 0-order diffracted beam; a ±1st-order diffracted beam; and a −1st-order diffracted beam, and guides them to the objective lens 5. A structure of the grating 3 will be described later in detail.

The beam splitter 4 passes the incident light emitted from the semiconductor laser 1, while reflecting the reflected beams of an optical disk 6 into a reflected light receiver 8.

The push-pull signal detecting section 10 includes a condensing lens 7, a cylindrical lens 9, and the reflected light receiver (reflected light receiving means) 8. The condensing lens 7 condenses incident light. The cylindrical lens 9 collects only rays traveling in a single direction from the incident light. The reflected light receiver 8 receives the 0-order diffracted beam and the ± 1st-order diffracted beams, which are reflected from the optical disk 6.

The light beam 33 emitted from the semiconductor laser 1 is incident on the collimator lens 2, converted into parallel light, and guided into the grating 3. Then, the light beam incident on the grating 3 is divided into three beams: a main beam 30 (the 0-order diffracted beam); a sub beam 31 (+1st-order diffracted beam); and a sub beam 32 (−1st-order diffracted beam). The three beams having passed through the beam splitter 4 are converged onto a track 61 on the optical disk 6 by the objective lens 5. Each of the divided light beams converged to the track 61 is reflected as an individual reflected light beam.

The light beams reflected from the optical disk 6 are transmitted through the objective lens 5, reflected by the beam splitter 4, and transmitted through the condenser lens 7 and the cylindrical lens 9. Then, the light beams are guided to the reflected light receiver 8 as the main beam 30, the sub beam 31, and the sub beam 32, individually.

The reflected light receiver 8 receives the light beams reflected from the optical disk 6. The reflected light receiver 8 includes a photodetector 8A, a photodetector 8B, and a photodetector 8C (hereinafter referred as photodetectors 8A, 8B, and 8C), which are two-part photodetectors having parting lines in a direction of the track. The photodetectors 8A, 8B, and 8C receive the main beam 30, the sub beam 31, and the sub beam 32, respectively. The reflected light receiver 8 obtains push-pull signals PP30, PP31, and PP32, which are difference signals produced by the photodetectors 8A, 8B, and 8C, respectively.

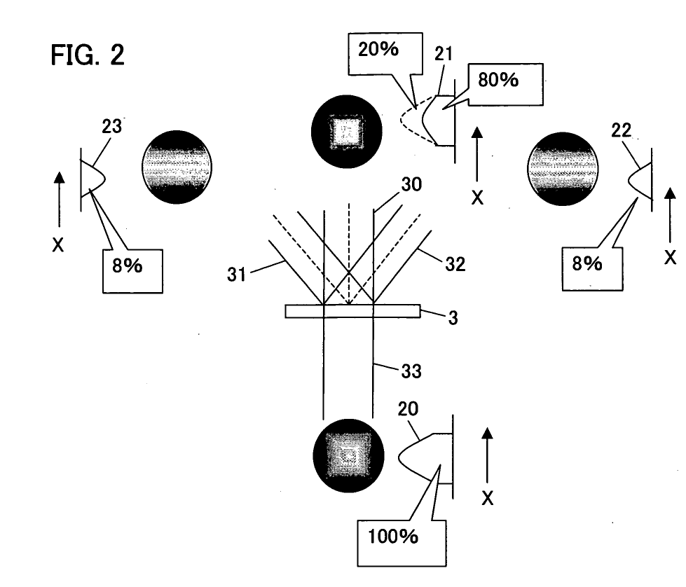

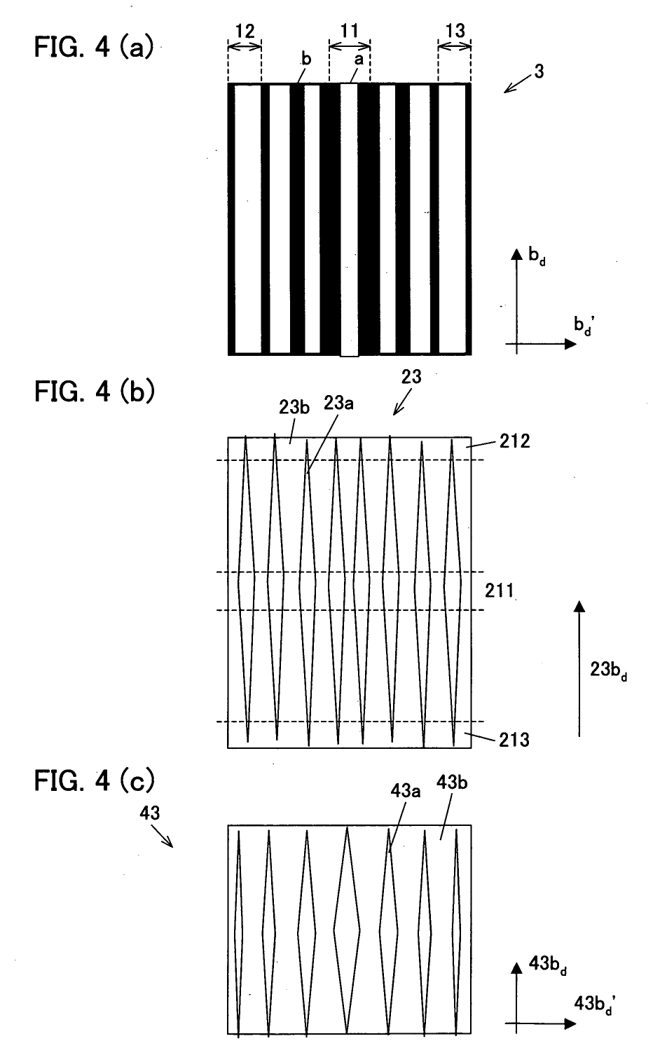

The grating 3 is designed so that the reduction rate of light intensity for the 0-order diffracted beam is decreased and intensities of the ±1st-order diffracted beams become stronger from the periphery toward the optical axis of the respective beams. With reference to FIG. 2, functions of the grating 3 are described below. FIG. 2 is an explanatory view representing a diffracted state of a light beam passing through the grating 3 in the optical pickup device 100. Note that, FIG. 4 represents a grating which divides a light beam emitted from the semiconductor laser 1 into a −1st-order diffracted beam, a 0-order diffracted beam, and a +1st-order diffracted beam with an intensity ratio of 1:10:1. However, the intensity ratio is not limited to this. Here, a direction along a radius of the optical disk 6 (hereinafter referred as radial direction) is x-direction, and a direction orthogonal to the radial direction, i.e., a direction of extension of the track on the optical disk (hereinafter referred as track direction) is y-direction.

As shown in FIG. 2, with the intensity ratio of 1:10:1 for the −1st-order diffracted beam, the 0-order diffracted beam, and the +1st-order diffracted beam, diffraction efficiency of the grating 3 is 8%:80%:8%. The remaining 4% accounts for the diffraction efficiency of the ±2nd-order diffracted beams or greater.

The x-direction intensity distribution of the light beam 33 emitted from the semiconductor laser 1 is in the form of a gaussian distribution 20 as shown in FIG. 2. By passing through the grating 3, the light beam 33 is divided into three beams: the main beam 30 (the 0-order diffracted beam); the sub beam 31 (the +1st-order diffracted beam); and the sub beam 32 (the −1st-order diffracted beam). The x-direction intensity distribution of the main beam 30 emitted from the grating 3 is represented by an intensity distribution 21. The intensity distribution 21 is uniform with a portion in the vicinity of the optical axis removed. The amount of removed light in the vicinity of the optical axis accounts for approximately 20% of the total amount of the light beam 33. In this way, the grating 3 converts the main beam 30 into the 0-order diffracted beam with a uniform and near-flat intensity distribution.

On the other hand, 16% of the total amount of the light beam 33 emitted from the semiconductor laser 1 is converted into the sub beams 31 and 32. That is, 8% of the total amount of the light beam 33 corresponds to each light amount of the sub beams 31 and 32. As shown in FIG. 2, the intensities of the sub beams 31 and 32 in the x-direction become weaker from the optical axis toward the periphery, as represented by intensity distributions 22 and 23.

As described above, the grating 3 improves light intensities of the main beam 30, the sub beam 31, and the sub beam 32. That is, the grating 3 controls the intensity distribution of the main beam 30 to be uniform and more flat in the x-direction, while reducing the intensities of the sub beams 31 and 32 from the optical axis toward the periphery in the x-direction. That is, the grating 3 improves Rim intensities of the main beam 30, the sub beam 31, and the sub beam 32. More specifically, in the x-direction, the grating 3 increases Rim intensity of the main beam 30, and decreases Rim intensities of the sub beams 31 and 32. Note that, “Rim intensity” is the intensity ratio of a luminous flux passing through the periphery of the objective lens 5 to a luminous flux passing through the center portion of the objective lens 5.

In the above description, the grating 3 improves light intensities of the main beam 30, the sub beam 31, and the sub beam 32 in the x-direction. However, the grating 3 may improve light intensities in the y-direction.

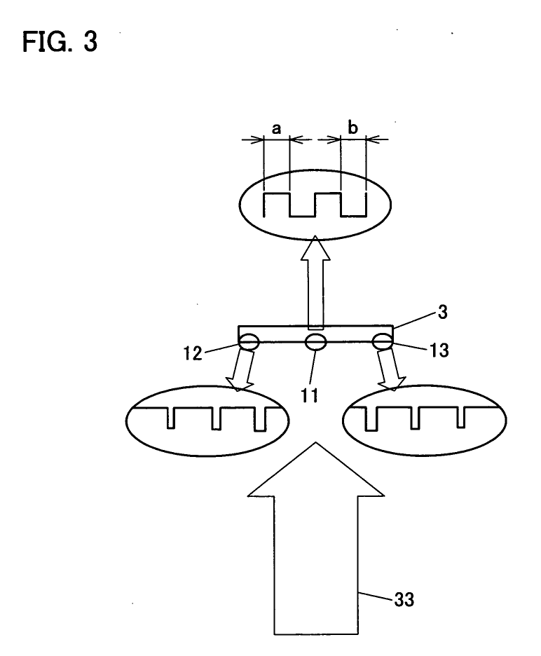

With reference to FIGS. 3 and 4, specific structures of the grating 3 are described below. FIG. 3 is a cross-sectional view illustrating a structure of the grating of the optical pickup device 100. FIGS. 4(a) through 4(c) are plan views illustrating specific structures of the grating of the optical pickup device 100, in which FIGS. 4(a) through 4(c) illustrate different grating surface structures of the grating.

As shown in FIG. 3, the grating 3 has a rectangular grating surface having a grating land (a) and grating grooves (b) on the side of the objective lens 5 (objective lens side). The grating land (a) has a width a_{w} and each grating groove (b) has a width b_{w}. A width ratio of the grating land (a) and the grating groove (b) (hereinafter referred as a_{w}/b_{w}) in a center region 11 is different from that in periphery regions 12 and 13. As used herein, the “center region 11” refers to a region on the grating surface of the grating 3 where a luminous flux in the vicinity of the optical axis of the light beam 33 emitted from the semiconductor laser 1 passes through, and the “periphery regions 12 and 13” refer to regions on the grating surface of the grating 3 where luminous fluxes in the vicinity of the periphery of the light beam 33 emitted from the semiconductor laser 1 pass through.

As shown in FIG. 3, the grating land (a) and the grating grooves (b) of the grating 3 are formed so that a_{w}/b_{w} approaches 1 in the center region 11 and 0 in the periphery regions 12 and 13. That is, the grating land (a) and the grating grooves (b) are formed such that a_{w}/b_{w} approaches 0 from the center region 11 toward the periphery regions 12 and 13.

Note that, the same result can be obtained when the land and grooves have the reversed proportions. Thus, the grating grooves and the grating land may be formed so that a_{w}/b_{w} approaches 0 from the center region toward the periphery regions, where a_{w} is the width of the grating groove and b_{w} is the width of the grating land.

In this way, the reduction rate of light intensity of the 0-order diffracted beam passing through the grating 3, i.e., the main beam 30, becomes greater for the luminous flux in the vicinity of the optical axis than for the luminous flux in the periphery parts. That is, the luminous flux of the main beam 30 has weak intensity in the vicinity of the optical axis and strong intensity in the periphery parts. As a result, the light beam 33 is incident on the objective lens 5 with its intensity distribution more flattened, as represented by the intensity distribution 21 converted from the intensity distribution 20 for example. This enables a micro spot to be formed on the optical disk 6, thereby improving resolution of signals reproduced from the optical disk 6.

On the other hand, the ±1st-order diffracted beams, i.e., the sub beams 31 and 32, have stronger light intensity in the luminous flux in the vicinity of the optical axis than that in the periphery parts. That is, the diffraction efficiency of the sub beams 31 and 32 is reduced from the optical axis toward the periphery parts. The sub beams 31 and 32 incident on the objective lens 5 are in the form of an ellipsoid whose gaussian distribution has a steep gradient without having light in the periphery parts. Thus, the sub beams 31 and 32 have no incident light in the periphery parts of the objective lens 5. Therefore, the actual numerical aperture (NA) of the objective lens 5 is reduced for the sub beams 31 and 32, with the result that the respective spot sizes of the sub beams 31 and 32 are increased. As a result, amplitudes of the push-pull signals PP31 and PP32, which are difference signals produced by the reflected light receiver 8 responsive to the sub beams 31 and 32, are significantly reduced. Therefore, position alignment is not required for the main beam 30, the sub beam 31, and the sub beam 32 in the optical pickup device 100. As to how the push-pull signals PP31 and PP32 of the sub beams 21 and 32, and a tracking error signal are produced, details will be described later.

With reference to FIG. 4, description is made below as to the shape of the grating surface of the grating in the optical pickup device 100.

As shown in FIG. 4(a), the grating land (a) and grating grooves (b) are formed on the grating surface of the grating 3. The grating land (a) has a width a_{w}, and each grating groove (b) has a width b_{w}. The grating grooves (b) are formed along a grating groove direction b_{d} on the grating surface of the grating 3. The grating land (a) and the grating grooves (b) of the grating 3 are formed so that a_{w}/b_{w} approaches 1 in the center region 11 and 0 in the periphery regions 12 and 13 in a direction b_{d}′ perpendicular to the grating groove direction bd. That is, the grating land (a) and grating grooves (b) of the grating 3 are formed so that a_{w}/b_{w} approaches 1 toward the center region 11 and 0 toward the periphery regions 12 and 13. The main beam 30 is incident on the objective lens 5 with its intensity distribution more flattened along the direction in which a_{w}/b_{w} is varied, i.e., the grating groove direction bd. This enables a micro spot to be formed on the optical disk 6 in the direction b_{d}′.

On the other hand, the ±1st-order diffracted beams passing through the grating 3, i.e., the sub beams 31 and 32, incident on the objective lens 5 are in the form of an ellipsoid whose gaussian distribution has a steep gradient without having light in the periphery parts in the direction b_{d}′. Thus, the sub beams 31 and 32 have no incident light in the periphery parts of the objective lens 5 in the direction b_{d}′. Therefore, the numerical apertures (NA) of the objective lens 5 for the sub beams 31 and 32 are reduced in the direction b_{d}′, with the result that the respective spot sizes of the sub beams 31 and 32 are increased.

In this way, the grating surface of the grating 3 is formed so as to improve the intensity distributions of the main beam 30, the sub beams 31, the sub beams 32 in the direction b_{d}′. By forming the grating surface of the grating 3 so that a_{w}/b_{w} approaches 0 in the direction b_{d}′ away from the center region 11, the grating surface can be fabricated easily.

Further, the grating surface of the grating may be formed so as to improve the intensity distributions of the main beam 30, the sub beam 31, and the sub beam 32 in the groove direction. A specific structure of such a grating surface is shown as a grating 23 in FIG. 4(b).

As shown in FIG. 4(b), a grating land 23a and grating grooves 23b are formed on the grating surface of the grating 23. The grating land 23a has a width a_{w}, and each grating groove b has a width b_{w}. The grating grooves 23b are formed in a grating groove direction 23b_{d} on the grating surface of the grating 23. As shown in FIG. 4(b), the grating land 23a is formed so that the width 23 a_{w} gradually becomes narrower toward peripheral regions 212 and 213 than in a center region 211. That is, the grating land 23a and the grating grooves 23b of the grating 23 are formed so that 23a_{w}/23b_{w} approaches 1 toward the center region 211 and 0 toward the peripheral regions 212 and 213 in the grating groove direction bd. That is, the grating land 23a and grating grooves 23b are formed such that 23a_{w}/23b_{w} approaches 0 from the center region 211 toward the periphery regions 212 and 213. In this case, the main beam 30 is incident on the objective lens 5 with its intensity distribution more flattened along the direction in which 23a_{w}/23b_{w} is varied, i.e., the grating groove direction 23b_{d}. This enables a micro spot to be formed on the optical disk 6 in the direction 23b_{d}.

On the other hand, the ±1st-order diffracted beams passing through the grating 23, i.e., the sub beams 31 and 32, incident on the objective lens 5 are in the form of an ellipsoid whose gaussian distribution has a steep gradient without having light in the periphery parts in the grating groove direction 23b_{d}. Thus, the sub beams 31 and 32 have no incident light in the periphery parts of the objective lens 5 in the grating groove direction 23b_{d}. Therefore, the actual numerical aperture (NA) of the objective lens 5 for the sub beams 31 and 32 is reduced in the direction 23b_{d}, with the result that the respective spot sizes of the sub beams 31 and 32 are increased.

Further, FIG. 4(c) shows an exemplary grating surface structure, which combines the grating surfaces of the gratings shown in FIGS. 4(a) and 4(b). As shown in FIG. 4(c), a grating land 43a and grating grooves 43b are formed on the grating surface of the grating 43. The grating land 43a has a width 43a_{w} and each grating groove 43b has a width 43b_{w}. The grating grooves 43b are formed in a grating groove direction 43b_{d} on the grating surface of the grating 43.

In FIG. 4(c), a direction 43b_{d}′ is perpendicular to the grating groove direction 43b_{d}. In the both directions, the grating land 43a and the grating grooves 43b of the grating 43 are formed so that 43a_{w}/43b_{w} approaches 1 toward a center region 411 and 0 toward the periphery regions 412 and 413. That is, the grating land 43a and grating grooves 43b are formed such that a_{w}/b_{w} approaches 0 from the center region 411 toward the periphery regions 412 and 413. The main beam 30 is incident on the objective lens 5 with its intensity distribution more flattened along the directions 43b_{d} and 43b_{d}′. This enables a micro spot to be formed on the optical disk 6 in the both directions 43b_{d} and 43b_{d}′. Further, in this case, the smallest spot can be focused on the optical disk 6 because the main beam 30 is converged in the both directions 43b_{d} and 43b_{d}′, thereby achieving excellent resolution for the signals reproduced from the optical disk 6.

Further, in the optical pickup device 100, the grating groove direction of the grating may be set appropriately in accordance with use of the optical disk 6. The grating grove direction may be set parallel to the radial direction or track direction of the optical disk 6.

Assume that the grating groove direction of the grating is set parallel to the radial direction of the optical disk 6. In this case, the grating surface of the grating 3 shown in FIG. 4(a) enables a micro spot to be formed in the track direction of the optical disk 6. On the other hand, the grating surface of the grating 23 shown in FIG. 4(b) enables a micro spot to be formed in the radial direction of the optical disk 6.

Further, assume that the grating groove direction of the grating is set parallel to the track direction of the optical disk 6. In this case, the grating surface of the grating 3 shown in FIG. 4(a) enables a micro spot to be formed in the radial direction of the optical disk 6. On the other hand, the grating surface of the grating 23 shown in FIG. 4(b) enables a micro spot to be formed in the track direction of the optical disk 6.

Further, in the optical pickup device 100, it is preferable that the grating 3 be disposed so that the main beam 30, the sub beam 31, and the sub beam 32 are incident in an area within an effective diameter of the objective lens 5, or more preferably within a half the effective diameter. That is, it is preferable that an area in which the grating surface is provided be within the effective diameter of the objective lens 5, or more preferably within a half the effective diameter.

In this way, the amplitudes of the push-pull signals PP31 and PP32 of the sub beams 31 and 32 can be reduced as close to zero as possible. This significantly simplifies the assembly and adjustment of the optical pickup device, because rotation adjustments are not required for the grating 3, which are accompanied by spot alignment of the main beam 30, the sub beam 31, and the sub beam 32. More details will be described later.

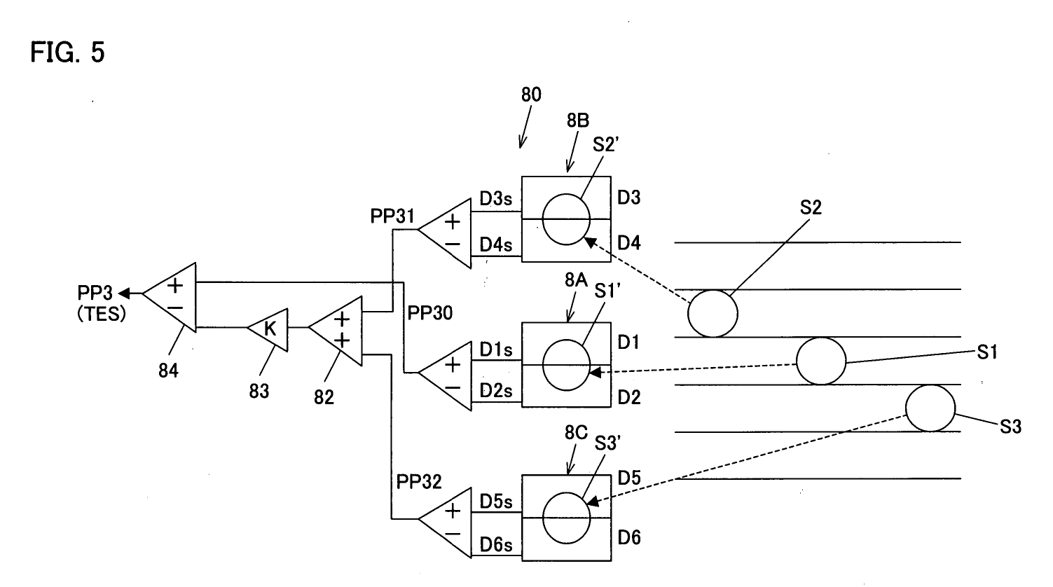

With reference to FIG. 5, description is made below as to the principle and circuit for detecting a tracking error signal TES. FIG. 5 is a circuit diagram illustrating how the tracking error signal TES is detected in the optical pickup device 100.

As shown in FIG. 5, the light beam emitted from the semiconductor laser 1 is divided into three beams: the main beam 30; the sub beam 31; and the sub beam 32 by the grating 3, and converged to three spots on the optical disk 6. Here, the spot of the main beam 30 is shown as a main spot S1, and the spots of the sub beams 31 and 32 are shown as sub spots S2 and S3, respectively. In the photodetectors 8A, 8B, and 8C of the reflected light receiver 8, the main spot S1, the sub spot S2, and the sub spot S3 are received as a main spot S1′, a sub spot S2′, and a sub spot S3′, respectively.

The photodetectors 8A, 8B, and 8C have light receiving sections D1 and D2, D3 and D4, and D5 and D6, respectively. The light receiving sections are divided in a direction parallel to the track direction of the optical disk 6. The tracking error signal TES is calculated by the following equation
TES=(D1s−D2s)−β[(D3s−D4s)+(D5s−D6s)] (1)
(β is a constant)
where D1s, D2s, D3s, D4s, D5s, and D6s are signals detected by the light receiving sections D1, D2, D3, D4, D5, and D6 are, respectively.

In the equation (1), β is set to represent an intensity ratio of the main spot S1 to the sub spots S2 and S3.

As shown in FIG. 5, a TES detecting circuit 80 includes arithmetic circuits 8A₁, 8B₁, and 8C₁, an arithmetic circuit 82, a constant generating circuit 83, and an arithmetic circuit 84. Each of the arithmetic circuits 8A₁, 8B₁, and 8C₁ has an addition input terminal and a subtraction input terminal. The respective addition input terminals and subtraction input terminals of the arithmetic circuits 8A₁, 8B₁, and 8C₁ are connected to the light receiving sections D1 and D2, D3 and D4, and D5 and D6, respectively.

The arithmetic circuit 82 has two addition input terminals, which are connected to the arithmetic circuits 8B₁ and 8C₁, respectively. The constant generating circuit 83 is connected to the arithmetic circuit 82.

Further, the arithmetic circuit 84 has an addition input terminal and a subtraction input terminal, which are connected to the arithmetic circuit 8A₁ and the constant generating circuit 83, respectively.

The detection signals D1s and D2s from the light receiving sections D1 and D2 are received by the arithmetic circuit 8A₁, and supplied to the arithmetic circuit 84 as the push-pull signal PP30, which is generated in the arithmetic circuit 8A₁ based on a difference between D1s and D2s (D1s−D2s). The detection signals D3s and D4s from the light receiving sections D3 and D4 and the detection signals D5s and D6s from the light receiving sections D5 and D6 are supplied to the arithmetic circuit 82 as the push-pull signal PP31 and the push-pull signal PP32, respectively, wherein the push-pull signal PP31 is generated in the arithmetic circuit 8B₁ based on a difference between D3s and D4s (D3s−D4s), and the push-pull signal PP32 is generated in the arithmetic circuit 8C₁ based on a difference between D5s and D6s (D5s−D6s).

The push-pull signals PP31 and PP32 are calculated in the arithmetic circuit 82 and the constant generating circuit 83, and supplied to the arithmetic circuit 84. As a result of calculation in the arithmetic circuit 84, the tracking error signal TES is generated in the TES detecting circuit 80.

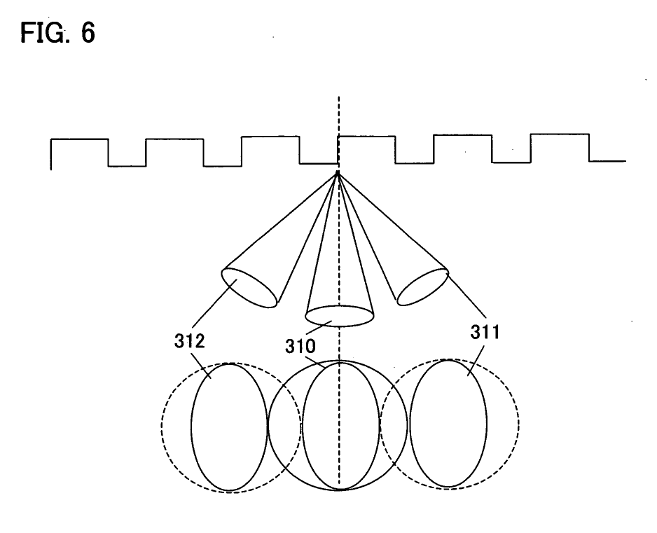

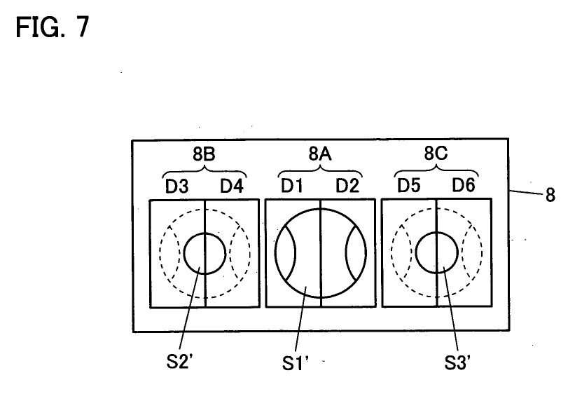

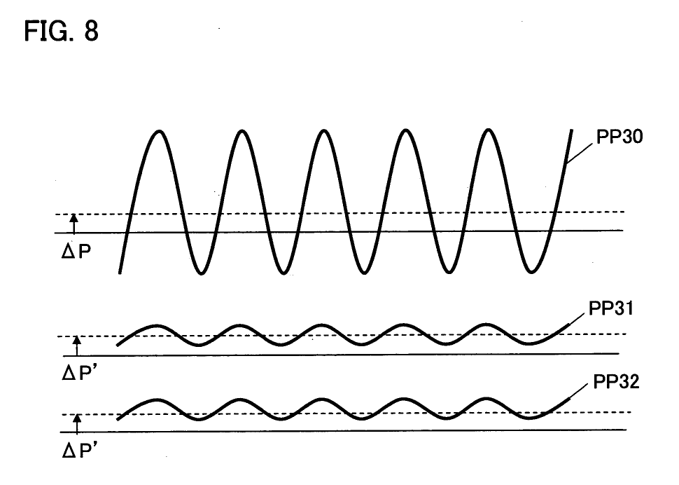

With reference to FIGS. 6 through 8, the following describes the push-pull signals PP30, PP31, and PP32 of the main beam 30, the sub beam 31, and the sub beam 32 in the optical pickup device 100, wherein the push-pull signals PP30, PP31, and PP32 are outputted as difference signals in response to the main beam 30, the sub beam 31, and the sub beam 32 being received in the reflected light receiver 8. FIG. 6 is a schematic view illustrating diffraction patterns of light beams projected on the optical disk 6. FIG. 7 is a plan view illustrating spots S1′, S2′, and S3′ of the reflected light beams received by the light receiving sections D1 through D6 of the reflected light receiver 8. FIG. 8 is a graph showing changes in the amplitudes of the push-pull signals PP30, PP31, and PP32, when the objective lens 5 shifts in the optical pickup device 100.

As shown in FIG. 6, when a light spot falls on the groove portion of the optical disk 6, the light is reflected to be diffracted beams 310, 311, and 312. Accordingly, in the reflected light receiver 8, the diffracted beams 310, 311, and 312 are received as an overlapping beam reflected from the optical disk 6. Further, in the light receiving sections of the reflected light receiver 8, a ball-patterned light spot is formed as an overlapping beam the diffracted beams 310, 311, and 312. The following describes the spots S1′, S2′, and S3′ of the reflected light beams received by the light receiving sections D1 through D6 of the reflected light receiver 8.

As shown in FIG. 7, a spot received by the light receiving sections D1 and D2 of the reflected light receiver 8, i.e., the spot S1′ of the main beam 30, is a ball-patterned spot.

On the other hand, the sub beams 31 and 32 are incident on the objective lens 5 in the form of an ellipsoid whose gaussian distribution has a steep gradient without having light in the periphery parts. Therefore, the actual numerical aperture (NA) of the objective lens 5 for the sub beams 31 and 32 are reduced, with the result that the respective spot sizes of the sub beams 31 and 32 are increased. As a result, the spots S2′ and S3′, which are received by the light receiving sections D3 and D4, and D5 and D6, respectively, have no light in the ball-patterned areas.

Thus, as shown in FIG. 8, the push-pull signals PP31 and PP32, which are detected from the spots S2′ and S3′, have amplitudes several fractions smaller than the amplitude of the push-pull signal 30 detected from the spot S1′.

Further, as shown in FIG. 8, when the objective lens 5 shifts or the optical disk 6 are tilts in the optical pickup device 100, the push-pull signals PP30, PP31, and PP32 are shifted (in phase) by an amount of Δp or Δp′ in accordance with the respective amounts of light. This causes an offset in the tracking error signal. In this case, by performing arithmetic calculations based on equation (2) below, a tracking error signal PP3 for canceling the offset can be detected.
PP30=PP30−k(PP31+PP32) (2)
(k is a constant)

Note that, in the optical pickup device 100, the constant k corrects a difference in the light intensities between the main beam 30 (0-order diffracted beam) and the sub beams 31 and 32 (±1st order diffracted beams), which are diffracted through the grating 3. When the intensity ratio of the main beam 30, the sub beam 31, and the sub beam 32 is a:b:b, the constant k is given as k=a/(2b) . . . (3).

As described above, in the optical pickup device 100, the amplitudes of the push-pull signals PP31 and PP32 are small. Therefore, there is no need to detect the tracking error signal PP3 for canceling the offset, by using both the push-pull signals PP31 and PP32. That is, by using either the push-pull signal PP31 or PP32, the error tracking signal PP3 is calculated by the following equation (4) or (5).
PP3=PP30−2k(PP31) (4)
PP3=PP30−2k(PP32) (5)

In conventional optical pickup devicees, fine rotation adjustment has been required for the grating surface of the grating, in order to adjust a phase difference between a ball-pattern fluctuating signal due to a tracking error of the sub beams and a ball-pattern fluctuating signal of the main beam. In the optical pickup device 100, however, the signals (push-pull signals PP31 and PP32) from the sub beams 31 and 32 do not contain ball-pattern fluctuating components due to tracking offset, and only a beam displacement signal is generated due to shifting of the objective lens 5. Further, the push-pull signals PP31 and 32 have almost no amplitude regardless of a depth of the groove of the optical disk 6.

This significantly simplifies the assembly and adjustment of the optical pickup device 100, because rotation adjustments are not required for the grating, which are accompanied by spot alignment of the main beam 30, the sub beam 31, and the sub beam 32.

Note that, the optical disk 6 used in the optical pickup device 100 may be any optical disk which optically carries out reproducing or recording. For example, the optical disk 6 may be a read-only pit disk, a recordable, reproducible and erasable phase change disk, magnetooptical disk, or recordable and reproducible write-once disk.

When a mass-produced pit (read-only) disk is applied to the optical pickup device 100, the objective lens tends to shift greatly under servo control, because the mass-produced pit disks are often eccentric and susceptible to surface fluctuations. However, in the optical pickup device 100, signals can be reproduced stably without causing a tracking offset in such a situation.

### Second Embodiment

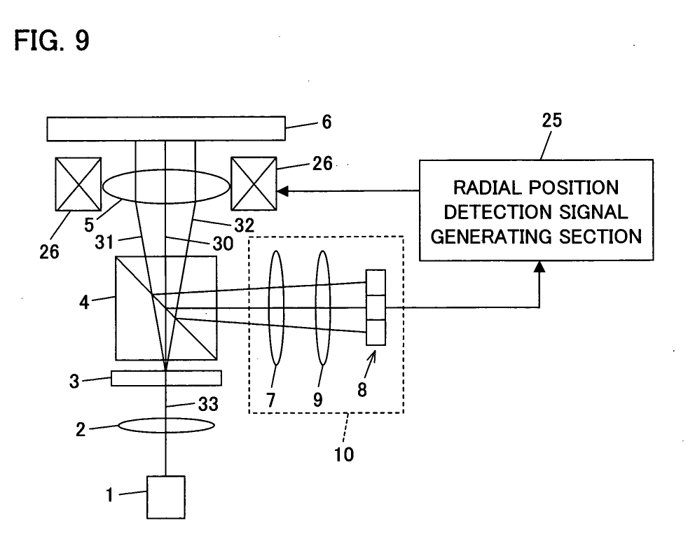

With reference to FIG. 9, the following describes another embodiment of the present invention. Note that, differences from the first embodiment are mainly described. Constituting elements having the same functions as those described in the first embodiment are indicated by the same reference numerals, and their explanations are omitted. Further, the various features described in the first embodiments may be suitably combined and applied also in the second embodiment. FIG. 9 shows a schematic structure of an optical pickup device 101 (optical pickup device) according to the second embodiment.

The optical pickup device 100 of the first embodiment uses the push-pull signals PP31 and PP32 to generate the tracking error signal. However, the optical pickup device 101 of the second embodiment uses the push-pull signals PP31 and PP32 of the sub beams 31 and 32 to generate a position detecting signal for detecting a radial position of the objective lens 5.

As shown in FIG. 9, the optical pickup device 101 includes a semiconductor laser (light source) 1, a collimator lens 2, a grating (diffractive optical element) 3, a beam splitter 4, an objective lens (converging means) 5, a push-pull signal detecting section (push-pull signal detecting means) 10, and a radial position detecting signal generating section 25, and an actuator 26.

The radial position detecting signal generating section 25 generates a signal for detecting a radial position of the objective lens 5, based on the push-pull signals PP31 and PP32, which are differential signals produced from the signals received by the reflected light receiver 8. The actuator 26 is provided as moving means for the objective lens 5.

A light beam 33 emitted from the semiconductor laser 1 is incident on the collimator lens 2, converted into parallel light, and guided to the grating 3. Then, the light beam incident on the grating 3 is divided into three beams: a main beam 30 (a 0-order diffracted beam); a sub beam 31 (a±1st-order diffracted beam); and a sub beam 32 (−1st-order diffracted beam). The three beams having passed through the beam splitter 4 are converged to a track 61 on an optical disk by the objective lens 5. Each of the divided light beams converged to the track 61 is reflected as an individual reflected light beam.

The light beams reflected from the optical disk 6 are transmitted through the objective lens 5, reflected on the beam splitter 4, and transmitted through the condenser lens 7 and the cylindrical lens 9. Then, the light beams are guided to the reflected light receiver 8 as the main beam 30, the sub beam 31, and the sub beam 32, individually.

The reflected light receiver 8 receives the light beams reflected from the optical disk 6. The reflected light receiver 8 includes a photodetector 8A, a photodetector 8B, and a photodetector 8C (hereinafter referred as photodetectors 8A, 8B, and 8C), which are two-part photodetectors having parting lines in a direction of the track. The photodetectors 8A, 8B, and 8C receive the main beam 30, the sub beam 31, and the sub beam 32, respectively. The reflected light receiver 8 obtains push-pull signals PP30, PP31, and PP32, which are difference signals produced by the photodetectors 8A, 8B, and 8C, respectively.

For example, in performing seek operation in the optical pickup device 101, the optical pickup device 101 moves entirely in a radial direction of the optical disk 6 under the control of only focusing servo. In order to prevent the objective lens 5 from oscillating, the radial position detecting signal generating section 25 generates a position detecting signal (radial position detecting signal) for detecting a radial position of the objective lens 5, based on the push-pull signals PP31 and PP32. The radial position detecting signal generating section 25 then inputs the radial position detecting signal to the actuator 26 as a control signal. In this manner, the objective lens 5 is prevented from oscillating during the seek operation of the optical pickup device 101.

In the optical pickup device 101, the radial position detecting signal for the objective lens can be calculated by the following equation (6);
Radial position detecting signal=(PP31+PP32) (6)

In one aspect of the invention, an optical pickup device is provided in which a light beam is divided into three beams by the grating, converged onto the optical disk by the objective lens, and reflected beams are individually received by two-part photodetectors so as to generate the tracking error signal, wherein the grating is designed so that diffraction efficiencies of the ±1st-order diffracted beams are reduced along a direction of a grating groove from the center part of the incident light beam.

In one aspect of the invention, an optical pickup device is provided in which a light beam is divided into three beams by the grating, converged onto the optical disk by the objective lens, and reflected beams are individually received by two-part photodetectors so as to generate the tracking error signal, wherein the grating is designed so that diffraction efficiencies of the ±1st-order diffracted beams are reduced along a direction perpendicular to a direction of a grating groove from the center part of the incident light beam.

In one aspect of the invention, an optical pickup device is provided in which a light beam is divided into three beams by the grating, converged to the optical disk by the objective lens, and reflected beams are individually received by two-part photodetectors so as to generate the tracking error signal, wherein the grating is designed so that diffraction efficiencies of the ±1st-order diffracted beams are reduced along directions perpendicular and parallel to a direction of a grating groove from the center part of the incident light beam.

As described above, the optical pickup device of the present invention further includes tracking error signal detecting means for detecting a tracking offset of the spots of the 0-order diffracted beam and the ±1st-order diffracted beams on the optical disk. The diffractive optical element is set so that a reduction rate of light intensity for the 0-order diffracted beam is reduced and the intensities of the ±1st-order diffracted beams are reduced from a vicinity of the optical axis toward the periphery parts.

Accordingly, the intensity distribution of the 0-order diffracted beam passing through the diffractive optical element is flattened. This provides improvement in the resolution of reproduced signals without increasing the number of components constituting the optical system. Further, position alignment of the diffractive optical element is not required because the intensities of the 1st-order diffracted beams passing through the diffractive optical element are higher in the vicinity of the respective optical axes than in the periphery parts. Thus, position alignment of the grating can be omitted during assembly of the optical pickup device.

Further, it is preferable that the optical pickup device of the present invention include reflected light receiving means, provided in the push-pull signal detecting means, for receiving reflected light of the 0-order diffracted beam and the pair of ±1st-order diffracted beams from the optical disk; and tracking error signal generating means for generating a tracking error signal, based on an output signal from the reflected light receiving means.

According to the arrangement, the reflected light receiving means receives the 0-order diffracted beam and the ±1st-order diffracted beams reflected from the optical disk, and outputs signals that indicate offset positions of the 0-ordered diffracted beam and the ±1 st-order diffracted beams in the reflected light receiving means. Further, the tracking error signal generating means generates a tracking error signal based on the output signal from the reflected light receiving means.

According to the arrangement, an optical pickup device is realized that causes no offset in the tracking error signal due to shifting of the converging means. Further, assembly and adjustment of the optical pickup device can be significantly simplified because position alignment of the diffractive optical element is not required.

Further, it is preferable that the optical pickup device of the present invention include reflected light receiving means, provided in the push-pull signal detecting means, for receiving reflected light of the 0-order diffracted beam and the pair of ±1st-order diffracted beams from the optical disk; and radial position detecting signal generating means for generating a radial position detecting signal for detecting a radial position of the converging means, based on an output signal from the reflected light receiving means.

According to the arrangement, the reflected light receiving means receives the 0-order diffracted beam and ±1st-order diffracted beams reflected from the optical disk, and outputs signals that indicate offset positions of the 0-ordered diffracted beam and the ±1st-order diffracted beams. Further, the radial position detection signal generating means generates a radial position detection signal for detecting a radial position of the converging means based on the output signal from the reflected light receiving means.

According to the arrangement, when moving the entire optical pickup device in the radial direction of the optical disk for example, the radial position detection signal generating means generates the radial position detecting signal for detecting a radial position of the converging means, based on the output signal from the reflected light receiving means. This prevents the converging means from oscillating. By using the radial position detecting signal as a control signal, the radial position detecting signal generating means controls the converging means.

According to the arrangement, even when the entire optical pickup device is moved in the radial direction, read and write operations can be desirably carried out for the optical disk by controlling the radial positon of the converting means.

Further, it is preferable in the optical pickup device of the present invention that the diffractive optical element has a grating groove, and the grating groove is set so that a diffraction efficiency of the 0-order diffracted beam is reduced and intensities of the pair of ±1st-order diffracted beams are decreased in a direction from a vicinity of an optical axis and along a direction perpendicular to a direction of the grating groove.

According to the arrangement, the diffractive optical element is set so that the diffraction efficiency of the 0-order diffracted beam is reduced along a direction of the grating groove from a vicinity of the optical axis. Accordingly, the 0-order diffracted beam incident on the objective lens has a uniform and more flat intensity distribution in the grating groove direction. As a result, the size of the spot formed on the optical disk in the grating groove direction is reduced. This realizes an optical pickup device in which crosstalk between the tracks on the optical disk is reduced and high-density data is recorded and reproduced.

Further, it is preferable in the optical pickup device of the present invention that the diffractive optical element has a grating groove, and the grating groove is set so that a reduction rate of light intensity for the 0-order diffracted beam is decreased and intensities of the pair of ±1st-order diffracted beams are decreased in a direction from a vicinity of an optical axis and along a direction perpendicular to a direction of the grating groove.

According to the arrangement, the diffractive optical element is set so that the diffraction efficiency of the 0-order diffracted beam is reduced along a direction perpendicular to the grating groove direction from a vicinity of the optical axis. Accordingly, the 0-order diffracted beam incident on the objective lens has a uniform and more flat intensity distribution in a direction perpendicular to the grating groove direction. As a result, the size of the spot formed on the optical disk in a direction perpendicular to the grating groove direction is reduced. This realizes an optical pickup device in which crosstalk between the tracks on the optical disk is reduced, and high-density data is recorded and reproduced without reducing the efficiency of using light.

Further, it is preferable in the optical pickup device of the present invention that the diffractive optical element has a grating groove, and the grating groove is set so that a reduction rate of light intensity for the 0-order diffracted beam is decreased and intensities of the pair of ±1st-order diffracted beams are decreased in a direction from a vicinity of an optical axis and along directions perpendicular and parallel to a direction of the grating grove.

According to the arrangement, the diffractive optical element is set so that the diffraction efficiency of the 0-order diffracted beam is reduced along directions perpendicular and parallel to the grating groove direction from a vicinity of the optical axis. Accordingly, the 0-order diffracted beam incident on the objective lens has a uniform and more flat intensity distribution in directions perpendicular and parallel to the grating groove direction. As a result, the size of the spot formed on the optical disk is reduced in the both directions. This realizes an optical pickup device in which crosstalk between the tracks on the optical disk is reduced, and high-density data is recorded and reproduced without reducing the efficiency of using the light.

Further, it is preferable in the optical pickup device of the present invention that the diffractive optical element includes a grating surface having a grating land and a grating groove, and wherein the grating land and the grating groove are formed so that a land-to-groove width ratio approaches 1 toward a center region of the diffractive optical element, and 0 toward periphery regions of the diffractive optical element.

According to the arrangement, the reduction rate of light intensity for the 0-order diffracted beam passing through the diffractive optical element is reduced by a greater amount in the vicinity of the optical axis than in the periphery parts of the optical axis. That is, the intensity of the 0-order diffracted beam is weak in the vicinity of the optical axis and strong in the periphery parts. As a result, the 0-order diffracted beam incident on the converging means has a uniform and more flat intensity distribution, enabling a micro spot to be formed on the optical disk. This realizes an optical pickup device in which crosstalk between the tracks on the optical disk is reduced, and high-density data is recorded and reproduced without reducing the efficiency of using the light.

According to the arrangement, the ±1st-order diffracted beams passing through the diffractive optical element are incident on the converging means, with their light intensities higher in the vicinity of the respective optical axes than in the periphery parts. Thus, the 1st-order diffracted beams have no incident light in the vicinity of the converging means. As a result, an optical pickup device is realized that causes no offset in the tracking error signal due to shifting of the converging means. In addition, assembly and adjustment of the optical pickup device can be significantly simplified because position alignment of the diffractive optical element is not required.

Further, it is preferable in the optical pickup device of the present invention that the diffractive optical element is set so that the 0-order diffracted beam and the pair of ±1st-order diffracted beams are incident on a region within an effective diameter of the converging means.

This enables the amplitudes of the push-pull signals to as close to zero as possible. The push-pull signals are obtained from the spots of the ±1st-order diffracted beams. Further, assembly and adjustment of the optical pickup device can be significantly simplified, because rotation adjustments are not required for the grating, which are accompanied by position alignment of the spots of the main beam 30, the sub beam 31, and the sub beam 32.

As described above, in the optical pickup device of the present invention, the resolution of the reproduced signals can be improved without increasing the number of components constituting the optical system. In addition, position alignment of the diffractive optical element can be omitted during assembly of the optical pickup device. Thus, the present invention is applicable to optical recording and reproducing apparatuses for recording and reproducing information, for example, such as a read-only pit disk, a recordable, reproducible and erasable phase change disk, a magnetooptical disk, a recordable and reproducible write-once disk, and the like.

The invention being thus described, it will be obvious that the same way may be varied in many ways. Such variations are not to be regarded as a departure from the spirit and scope of the invention, and all such modifications as would be obvious to one skilled in the art are intended to be included within the scope of the following claims.

What is claimed is:

1. An optical pickup device comprising:
a light source;
a diffractive optical element for dividing light emitted from the light source into a 0-order diffracted beam and a pair of ±1st-order diffracted beams;
converging means for converging the 0-order diffracted beam and the pair of ±1st-order diffracted beams on an optical disk; and
push-pull signal detecting means for detecting a push-pull signal from respective spots of the 0-order diffracted beam and the pair of ±1st-order diffracted beams,
the diffractive optical element being set so that a reduction rate of light intensity for the 0-order diffracted beam is decreased and respective intensities of the pair of ±1st-order diffracted beams are decreased in a direction from a vicinity of an optical axis toward periphery parts.

2. The optical pickup device of claim 1, further comprising:
reflected light receiving means, provided in the push-pull signal detecting means, for receiving reflected light of the 0-order diffracted beam and the pair of ±1st-order diffracted beams from the optical disk; and
tracking error signal generating means for generating a tracking error signal, based on an output signal from the reflected light receiving means.

3. The optical pickup device of claim 1, further comprising:
reflected light receiving means, provided in the push-pull signal detecting means, for receiving reflected light of the 0-order diffracted beam and the pair of ±1st-order diffracted beams from the optical disk; and
radial position detecting signal generating means for generating a radial position detecting signal for detecting a radial position of the converging means, based on an output signal from the reflected light receiving means.

4. The optical pickup device of claim 1, wherein the diffractive optical element has a grating groove, and the grating groove is set so that a reduction rate of light intensity for the 0-order diffracted beam is decreased and intensities of the pair of +±1st-order diffracted beams are decreased in a direction from a vicinity of an optical axis and along a direction of the grating groove.

5. The optical pickup device of claim 1, wherein the diffractive optical element has a grating groove, and the grating groove is set so that a reduction rate of light intensity for the 0-order diffracted beam is decreased and intensities of the pair of ±1st-order diffracted beams are decreased in a direction from a vicinity of an optical axis and along a direction perpendicular to a direction of the grating groove.

6. The optical pickup device of claim 1, wherein the diffractive optical element has a grating groove, and the grating groove is set so that a reduction rate of light intensity for the 0-order diffracted beam is decreased and intensities of the pair of ±1st-order diffracted beams are decreased in a direction from a vicinity of an optical axis and along directions perpendicular and parallel to a direction of the grating grove.

7. The optical pickup device of claim 1, wherein the diffractive optical element includes a grating surface having a grating land and a grating groove, and wherein the grating land and the grating groove are formed so that a land-to-groove width ratio approaches 1 toward a center region of the diffractive optical element, and 0 toward periphery regions of the diffractive optical element.

8. The optical pickup device of claim 1, wherein the diffractive optical element is set so that the 0-order diffracted beam and the pair of ±1st-order diffracted beams are incident on a region within an effective diameter of the converging means.
